(19) United States
(12) Patent Application Publication
(10) Pub. No.: US 2025/0189106 A1
(43) Pub. Date: Jun. 12, 2025

(54) LIGHTING HEADGEAR

(71) Applicant: Carlos Arteaga, Porterville, CA (US)

(72) Inventor: Carlos Arteaga, Porterville, CA (US)

(21) Appl. No.: 18/968,882

(22) Filed: Dec. 4, 2024

Related U.S. Application Data
(60) Provisional application No. 63/606,728, filed on Dec. 6, 2023.

(51) Int. Cl. F21V 21/084; A42B 1/244; F21L 4/02; F21V 19/02; F21Y 103/10; F21Y 113/00; F21Y 115/10

(52) U.S. Cl. CPC F21V 21/084; A42B 1/244; F21L 4/02; F21V 19/02; F21Y 2103/10; F21Y 2113/00; F21Y 2115/10

(57) ABSTRACT

A lighting headgear can be worn over a head by a user to illuminate objects in a workplace. The lighting headgear includes a body member with a ring-shaped profile that can be positioned around the head. An arch member extends between the left end and the right end of the body member. A control panel mounted to the front end of the body member includes a button to turn on and off the lights. A lamp member is pivotally mounted to the control panel. Two LED strips are coupled adjacent to and on the left and right of the control panel. Batteries and size-adjusting members are also included.

### CROSS-REFERENCE TO RELATED APPLICATIONS

This application claims priority from a U.S. Provisional Patent Appl. No. 63/606,728, filed on Dec. 6, 2023, which is incorporated herein by reference in its entirety.

### FIELD OF INVENTION

The present invention relates to a lighting headgear, and more particularly, the present invention relates to an LED-based headlamp.

### BACKGROUND

A well-lit area is essential in workplaces, in particular, the work requiring fastening of screws, operating electronic equipment, and the like. For example, mechanics, plumbers, and electricians generally require good lighting for visibility. Workers often have to work in tight spaces and deal with complex equipment. Such places are not always well-lit, which makes it challenging to see things clearly from the right angles.

Torch lights can be used but the torch lights occupy the hands and are not desired. Also, focusing on using the torch light can be problematic.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a headlamp with enhanced visibility.

Still, another object of the present invention is that the headlamp provides hands-free operation.

Yet another object of the present invention is that the headlamp provides for improved safety.

A further object of the present invention is that the headlamp may increase productivity.

Still, a further object of the present invention is that the headlamp is versatile in use.

Yet, a further object of the present invention is that the headlamp is comfortable to use.

An additional object of the present invention is that the headlamps are energy efficient.

In one aspect, disclosed is a lighting headgear configured to be worn over a user's head. The lighting headgear comprises a body member of a ring shape profile and is configured to be positioned around the head, the body member has a left end, a right end, a front end, and a rear end; an arch member extends between the left end and the right end of the body member; a control panel mounted to the front end of the body member; a lamp member pivotally mounted to the control panel; a first LED strip coupled adjacent to and on a left of the control panel; and a second LED strip coupled to adjacent to and on a right of the control panel. The lighting headgear further comprises a left battery mounted on the left end of the body member and a right battery mounted on the body member at the right end. The lighting headgear further comprises a size-adjusting member mounted on the rear end of the body member and is configured to tighten and loosen the body member around the head of the user. The size-adjusting member comprises a dial; and a strap running around on an inner side of the body member, wherein free ends of the strap are fastened to the dial such that turning the dial in one direction tightens the strap and turning the dial in another direction loosens the strap. The lighting headgear further comprises a foam layer running around on the inner side of the body member.

In one aspect, the body member is rigid while the arch member is flexible. The body member is rigid while the arch member is also rigid.

In one aspect, disclosed is a method for illuminating an object in a workspace, the method comprises: providing a body member with a ring shape profile configured to be positioned around the head, the body member has a left end, a right end, a front end, and a rear end; coupling an arch member between the left end and the right end of the body member; mounting a control panel to the front end of the body member; pivotally mounting a lamp member to the control panel; coupling a first LED strip adjacent to and on a left of the control panel; and coupling a second LED strip adjacent to and on a right of the control panel. The method further comprises mounting a left battery on the left end of the body member; and mounting a right battery on the body member at the right end. The method further comprises mounting a size-adjusting member on the rear end of the body member, wherein the size-adjusting member is configured to tighten and loosen the body member around the head of the user. The size-adjusting member comprises a dial; and a strap running around on the inner side of the body member, wherein the free ends of the strap are fastened to the dial such that turning the dial in one direction tightens the strap, and turning the dial in another direction loosens the strap. The method further comprises disposing a foam layer around the inner side of the body member.

In one aspect, the position of the lamp member is a critical feature of the invention. By having an adjustable main beam coming down towards the nose at eye level and between the eyes, one can see things like no other headlamp.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows a perspective view of a headlamp, according to an exemplary embodiment of the present invention.

FIG. 2 shows another view of the headlamp, according to an exemplary embodiment of the present invention.

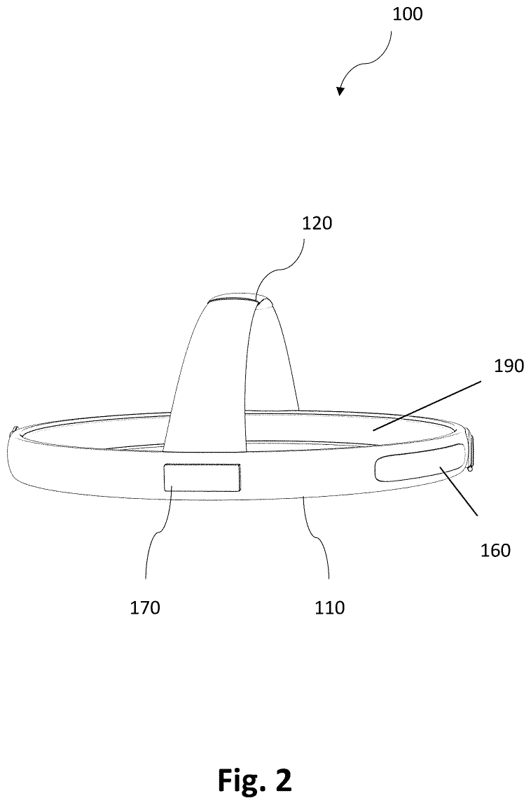

FIG. 3 shows another view of the headlamp, according to an exemplary embodiment of the present invention.

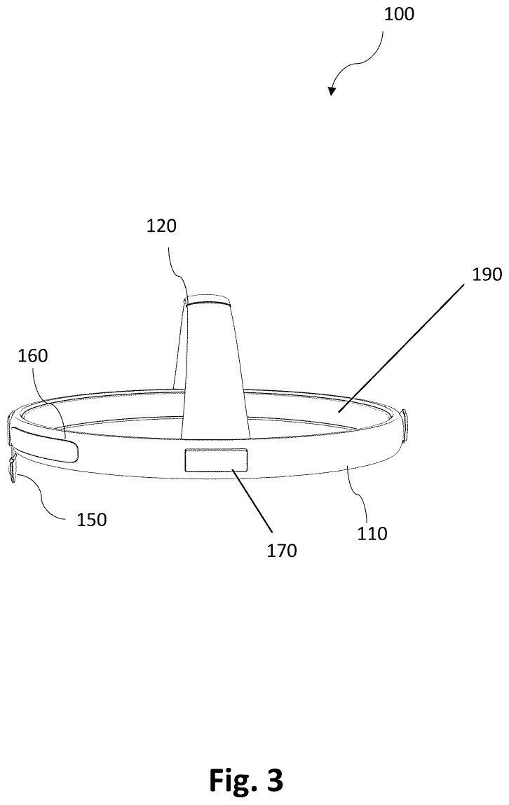

FIG. 4 shows another view of the headlamp, according to an exemplary embodiment of the present invention.

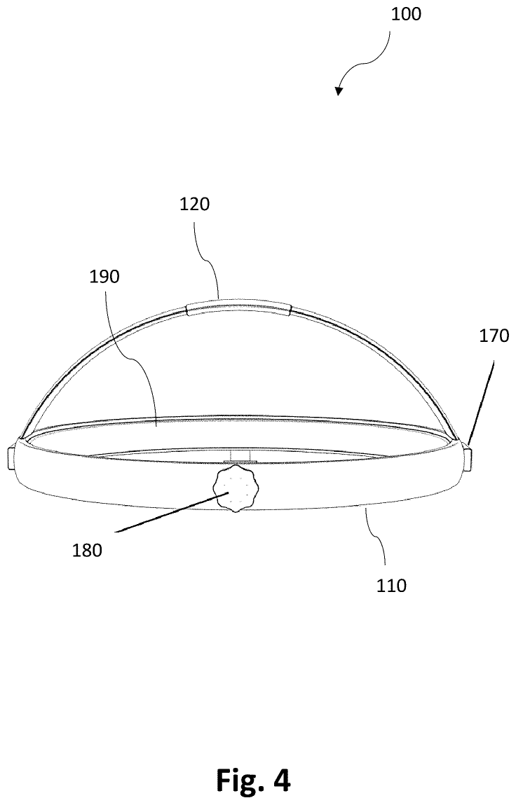

FIG. 5 shows another view of the headlamp, according to an exemplary embodiment of the present invention.

FIG. 6 shows another view of the headlamp, according to an exemplary embodiment of the present invention.

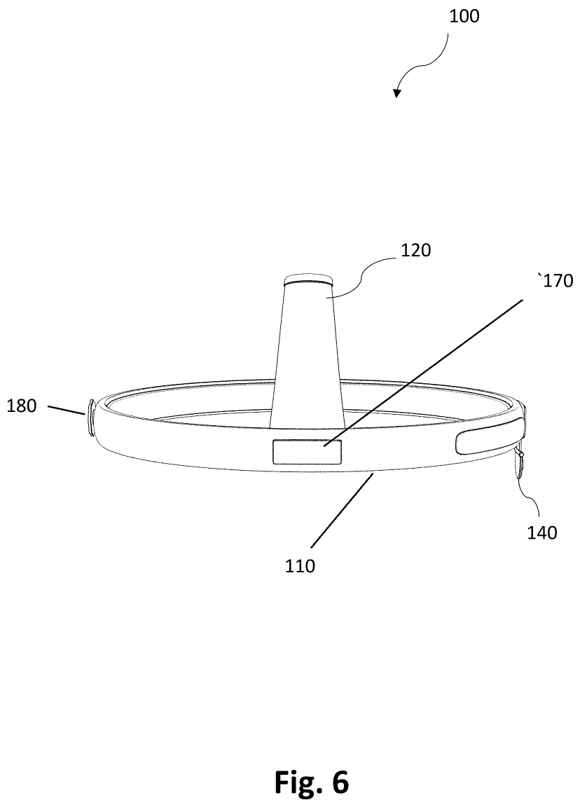

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the allowed claims of any resulting patent will best define the scope of the invention.

Disclosed is a headlamp for enhanced and focused light in work areas. The disclosed headlamp can provide enhanced visibility. The headlamp provides a powerful, adjustable light source, allowing users to see clearly and work with precision in challenging lighting conditions. The headlamp allows for hands-free operation. It frees up the user's hands, enabling them to work more efficiently and safely without the need to hold a flashlight. Also, better visibility reduces the risk of accidents and errors during complex and delicate tasks, thus enhancing safety. Jobs can be completed faster due to improved visibility and ease of maneuvering in tight spaces, thus improving productivity.

The disclosed headlamp may be suitable for a wide range of professions and activities beyond the trades, such as camping, hiking, and DIY projects. The headlamp provides a comfortable fit for a secure fit for extended use. The headlamp eliminates the need for frequent recharging or battery replacement, thus is energy efficient.

The disclosed headlamp can provide bright and focused light making it much easier for professionals to work in low-light or no-light conditions, ensuring they can see what they're doing even in the darkest spots. The light can be focused relative to the eyes of the user while illuminating things in front of the eyes.

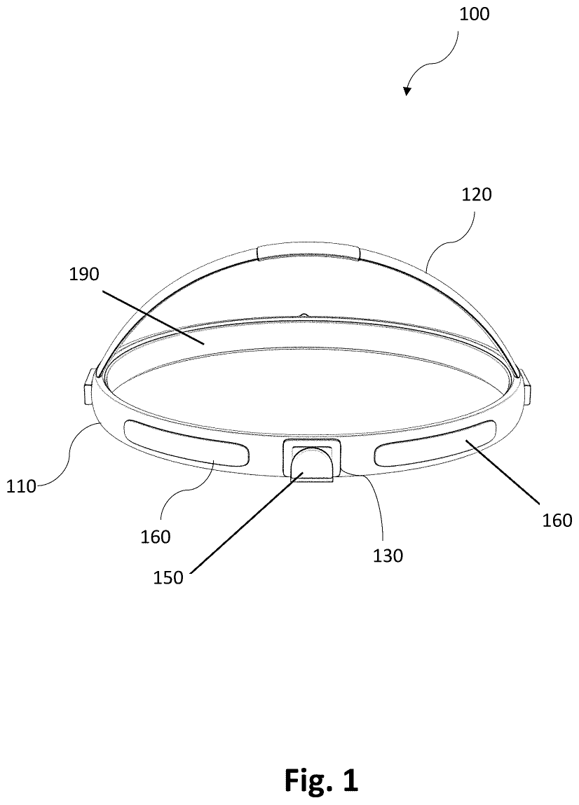

Referring to FIG. 1 shows a perspective view of the disclosed headlamp, also referred to herein as a lighting headgear. The lighting headgear is configured to be worn over the head of a wearer. The wearer of the disclosed lighting headgear is also referred to as a user. The term “user” as used herein and throughout this disclosure refers to any person wearing the disclosed lighting headgear over their head for lightning. The lighting headgear 100 includes a ring-shaped body member 110 that may be positioned around the head of the user. The body member 110 may have a left end, a right end, a front end, and a rear end. An arc member 120 extends between the left and right ends of the body member. When the lighting headgear is worn by the user, the arc member traverses over the head of the user. A control panel 130 may be mounted to the front end of the body member. The control panel may include a power button 140 to turn on and off the lights. The control panel may also include a button to increase or decrease the intensity and/or color of the lights. In certain implementations, the two buttons i.e., for turning the lights on and off and changing the intensity may be the same or different.

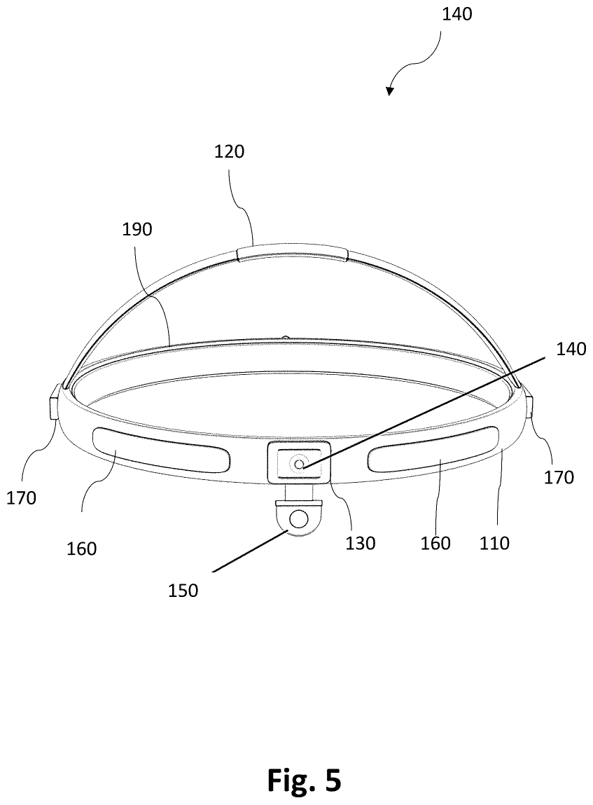

A lamp member 150 may be pivotally coupled to the control panel so that the lamp member may be positioned between the eyes of the user. The lamp member can be pivoted and tilted at multiple angles making it versatile in use. The user can focus the light on any object in front of their eyes by changing the angle of the lamp member. For example, the lamp member can be turned upwards or downwards in between the eyes. FIG. 1 shows the lamp member 150 mounted to the control panel 130, and the lamp member 150 is shown pivoted upwards, and FIG. 5 shows the lamp member 150 pivoted downwards.

The lighting headgear further includes two led strips 160 mounted adjacent to and on the left and right sides of the control panel. While the lamp member may provide focused and adjustable light, the two LEDs may provide general illumination in front of the user. These two LED strips may also be turned on and off through the control panel.

Batteries 170 can also be included to power the lights. The batteries may be rechargeable batteries or disposable batteries. Examples of rechargeable batteries include lithium-ion batteries. The batteries may be connected to the control panel. Drawings show two batteries on the left and right ends of the body member. The use of two batteries on opposite sides may allow for weight distribution while adding more battery capacity.

On the rear end of the body member may be a size adjustment member 180 that may allow tightening and loosening of the body member around the head. The size adjustment member may be in the form of a dial that can be rotated with a hand. A strap running along the inner side of the body member may be fastened to the dial at its two free ends. Turning the dial in one direction may tighten the strap around the user's head and turning the dial in the opposite direction may loosen the strap.

A foam layer 190 may be provided on the inner side of the body member 110. The foam layer may provide cushioning preventing the body member or the strap from pinching the skin of the user. The foam layer may be made from any suitable material, such as memory foam, polyurethane foam, and the like. The foam layer may be made from any skin-friendly material. The body member and the arch member are narrow in shape and thus only a very limited portion of the head is covered by the lighting headgear. The body member may be made from any suitable rigid member, preferably, light in weight. Examples of such materials for making the body member include plastic and aluminum. It is to be noted that any suitable rigid material for making the body member is within the scope of the present invention. While the body member may be made rigid, the arch member may be made rigid or flexible.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A lighting headgear configured to be worn over a head of a wearer, the lighting headgear comprises:
a body member of a ring shape profile and configured to be positioned around the head, the body member has a left end, a right end, a front end, and a rear end;
an arch member extends between the left end and the right end of the body member;
a control panel mounted to the front end of the body member;
a lamp member pivotally mounted to the control panel, wherein the lamp member is configured to project an adjustable beam at eye level between eyes;
a first LED strip coupled adjacent to and on a left of the control panel; and
a second LED strip coupled to adjacent to and on a right of the control panel.

2. The lighting headgear of claim 1, wherein the lighting headgear further comprises:
a left battery mounted on the left end of the body member; and
a right battery mounted on the body member at the right end.

3. The lighting headgear of claim 2, wherein the lighting headgear further comprises:
a size-adjusting member mounted on the rear end of the body member and is configured to tighten and loosen the body member around the head of the wearer.

4. The lighting headgear of claim 3, wherein the size-adjusting member comprises:
a dial; and
a strap running around on an inner side of the body member, wherein free ends of the strap are fastened to the dial such that turning the dial in one direction tightens the strap and turning the dial in an opposite direction loosens the strap.

5. The lighting headgear of claim 3, wherein the lighting headgear further comprises:
a foam layer running around on an inner side of the body member.

6. The lighting headgear of claim 5, wherein the body member is rigid while the arch member is flexible.

7. The lighting headgear of claim 5, wherein the body member is rigid while the arch member is also rigid.

8. A method for illuminating an object in a workspace, the method comprises:
providing a body member of a ring shape profile and configured to be positioned around a head of a wearer, the body member has a left end, a right end, a front end, and a rear end;
coupling an arch member between the left end and the right end of the body member;
mounting a control panel to the front end of the body member;
pivotally mounting a lamp member to the control panel;
coupling a first LED strip adjacent to and on a left of the control panel; and
coupling a second LED strip adjacent to and on a right of the control panel.

9. The method of claim 8, wherein the method further comprises:
mounting a left battery on the left end of the body member; and
mounting a right battery on the body member at the right end.

10. The method of claim 9, wherein the method further comprises:
mounting a size-adjusting member on the rear end of the body member, wherein the size-adjusting member is configured to tighten and loosen the body member around the head of the wearer.

11. The method of claim 10, wherein the size-adjusting member comprises:
a dial; and
a strap running around on an inner side of the body member, wherein free ends of the strap are fastened to the dial such that turning the dial in one direction tightens the strap and turning the dial in an opposite direction loosens the strap.

12. The method of claim 10, wherein the method further comprises:
disposing a foam layer around an inner side of the body member.

13. The method of claim 12, wherein the body member is rigid while the arch member is flexible.

14. The method of claim 12, wherein the body member is rigid while the arch member is also rigid.
